(19) United States
(12) Patent Application Publication
(10) Pub. No.: US 2024/0340027 A1
(43) Pub. Date: Oct. 10, 2024

(54) RADIO FREQUENCY CIRCUIT AND COMMUNICATION DEVICE

(71) Applicant: Murata Manufacturing Co., Ltd., Nagaokakyo-shi (JP)

(72) Inventors: Hidenori OBIYA, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 18/748,506

(22) Filed: Jun. 20, 2024

Related U.S. Application Data
(63) Continuation of application No. PCT/JP2022/044147, filed on Nov. 30, 2022.

(30) Foreign Application Priority Data
Dec. 24, 2021 (JP) 2021-211605

(51) Int. Cl. H04B 1/00; H04B 1/44; H04L 5/14

(52) U.S. Cl. CPC H04B 1/0064; H04B 1/44; H04L 5/14

(57) ABSTRACT

A radio frequency circuit can simultaneously transfer a signal in Band A and a signal in Band B, and includes: a first power amplifier supporting a first power class; a second power amplifier supporting a second power class for a transmission power higher than a transmission power of the first power class; a switch that includes a first common terminal connected to a first antenna terminal, a first terminal, and a second terminal; a first filter connected between the first power amplifier and the first terminal, and has a first passband that includes a portion of the first band; a second filter that includes an input end connected to the second power amplifier and an output end connected to a second antenna terminal via no switch, and has a second passband that includes a portion of the second band; and a third filter connected to the second terminal.

### CROSS-REFERENCE TO RELATED APPLICATIONS

This is a continuation application of PCT International Application No. PCT/JP2022/044147 filed on Nov. 30, 2022, designating the United States of America, which is based on and claims priority to Japanese Patent Application No. 2021-211605 filed on Dec. 24, 2021. The entire disclosures of the above-identified applications, including the specifications, drawings, and claims are incorporated herein by reference in their entirety.

### TECHNICAL FIELD

The present disclosure relates to a radio frequency circuit and a communication device.

### BACKGROUND

The 3rd Generation Partnership Project (3GPP (registered trademark)) has been discussing transfer of signals in a power class (such as Power Class 2, for example) that allows a maximum output power higher than that of a conventional class (U.S. Unexamined Patent Application Publication No. 2015/0133067).

### SUMMARY

### Technical Problems

However, as recognized by the present inventor, in a case of transferring a signal in a power class that allows a maximum output power higher than that of a conventional class, there is concern that quality of the signal transferred by the radio frequency circuit deteriorates since intermodulation distortion with, for example, another signal that is simultaneously transferred increases.

In view of this, the present disclosure provides a radio frequency circuit and a communication device that reduce deterioration in quality of signals in a power class that allows a high maximum output power.

### Solutions

In order to provide such a radio frequency circuit, a radio frequency circuit according to an aspect of the present disclosure is a radio frequency circuit configured to simultaneously transfer a signal in a first band in a first power class and a signal in a second band in a second power class for a transmission power higher than a transmission power of the first power class, the radio frequency circuit including: a first antenna terminal; a second antenna terminal; a first power amplifier configured to support the first power class; a second power amplifier configured to support the second power class; a switch that includes a first common terminal, a first terminal, and a second terminal, the first common terminal being connected to the first antenna terminal; a first filter that includes an input end connected to the first power amplifier and an output end connected to the first terminal, the first filter having a first passband that includes at least a portion of the first band; a second filter that includes an input end connected to the second power amplifier and an output end connected to the second antenna terminal via no switch, the second filter having a second passband that includes at least a portion of the second band; and a third filter connected to the second terminal, the third filter having a third passband.

A radio frequency circuit according to an aspect of the present disclosure is a radio frequency circuit configured to simultaneously transfer a signal in a first band in a first power class and a signal in a second band in a second power class for a transmission power higher than a transmission power of the first power class, the radio frequency circuit including: a first antenna terminal; a second antenna terminal; a first power amplifier configured to support the first power class; a second power amplifier configured to support the second power class; a first switch that includes a first common terminal, a first terminal, and a second terminal, the first common terminal being connected to the first antenna terminal; a second switch that includes a second common terminal, a third terminal, and a fourth terminal, the second common terminal being connected to the second antenna terminal; a first filter that includes an input end connected to the first power amplifier and an output end connected to the first terminal, the first filter having a first passband that includes at least a portion of the first band; a second filter that includes an input end connected to the second power amplifier and an output end connected to the third terminal, the second filter having a second passband that includes at least a portion of the second band; a third filter connected to the second terminal, the third filter having a third passband; and a fourth filter connected to the fourth terminal, the fourth filter having a fourth passband. The first switch includes a silicon semiconductor, and the second switch includes a compound semiconductor.

### Advantageous Effects

According to the present disclosure, a radio frequency circuit and a communication device that reduce deterioration in quality of signals in a power class that allows a high maximum output power can be provided.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a circuit configuration of a radio frequency circuit and a communication device according to Embodiment 1.

FIG. 2 illustrates a circuit configuration of a radio frequency circuit according to Variation 1.

FIG. 3 illustrates a circuit configuration of a radio frequency circuit according to Variation 2.

FIG. 4 illustrates a circuit configuration of a radio frequency circuit according to Variation 3.

FIG. 5 illustrates a circuit configuration of a radio frequency circuit and a communication device according to Embodiment 2.

### DESCRIPTION OF EMBODIMENTS

The following describes in detail embodiments of the present disclosure. Note that the embodiments described below each show a general or specific example. The numerical values, shapes, materials, elements, and the arrangement and connection of the elements, for instance, described in the following embodiments are examples, and thus are not intended to limit the present disclosure. Out of the elements in the embodiments and variations below, elements not recited in any of the independent claims are described as optional elements. In addition, the sizes of elements and ratios of the sizes of the elements illustrated in the drawings are not necessarily accurate. Throughout the drawings, the same numeral is given to substantially the same element, and redundant description may be omitted or simplified.

In the following, a term that indicates a relation between elements such as parallel or perpendicular, a term that indicates the shape of an element such as quadrilateral, and a numerical range do not necessarily have only strict meanings, but also cover substantially equivalent ranges that include a difference of about several percent, for example.

In the circuit configuration of the present disclosure, “being connected” includes not only the case of being directly connected by a connection terminal and/or a line conductor, but also the case of being electrically connected via another circuit element. “Being connected between A and B” means being connected between A and B and to both of A and B, and includes, in addition to a series connection to a path that connects A and B, parallel connection (shunt connection) between the path and ground.

In the arrangement of components of the present disclosure, a “component being disposed on a board” includes the component being disposed on a principal surface of the board and the component being disposed in the board. A “component being disposed on a principal surface of a board” includes the component being disposed above the principal surface without touching the principal surface (for example, the component being stacked on another component disposed in contact with the principal surface), in addition to the component being disposed on the principal surface in contact therewith. A “component being disposed on a principal surface of a board” may include the component being disposed in a recess formed in the principal surface. A “component being disposed in a board” includes the entirety of the component being disposed between two principal surfaces of the board but a portion of the component not being covered with the board and includes only a portion of the component being disposed in the board, in addition to the component being capsulated in a module board.

In the present disclosure, a “signal path” means a transfer line that includes, for instance, a wire through which a radio frequency signal propagates, an electrode directly connected to the wire, and a terminal directly connected to the wire or the electrode.

### Embodiment 1

### [1 Circuit Configuration of Radio Frequency Circuit 1 and Communication Device 5]

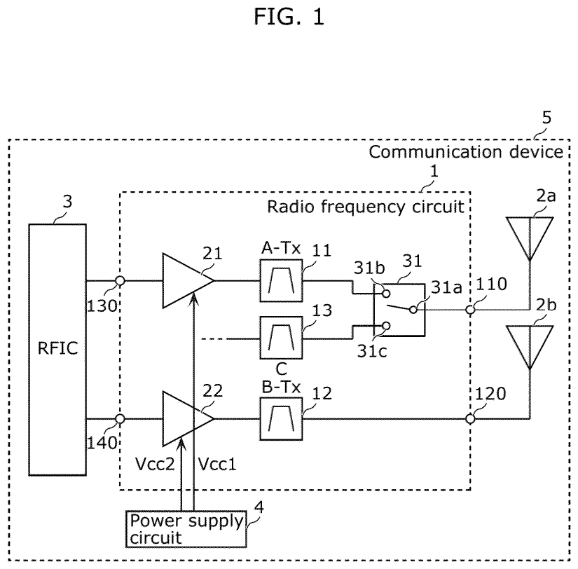

A circuit configuration of radio frequency circuit 1 according to the present embodiment and communication device 5 that includes radio frequency circuit 1 is to be described with reference to FIG. 1. FIG. 1 illustrates a circuit configuration of radio frequency circuit 1 and communication device 5 according to Embodiment 1.

### [1.1 Circuit Configuration of Communication Device 5]

Communication device 5 corresponds to so-called user equipment (UE), and typically is a mobile phone, a smartphone, or a tablet computer, for instance. Such communication device 5 includes radio frequency circuit 1, antennas 2a and 2b, radio frequency integrated circuit (RFIC) 3, and power supply circuit 4.

Radio frequency circuit 1 transfers radio frequency signals between RFIC 3 and antennas 2a and 2b. An internal configuration of radio frequency circuit 1 is to be described later.

Antenna 2a is connected to antenna terminal 110 (a first antenna terminal) of radio frequency circuit 1. Antenna 2b is connected to antenna terminal 120 (a second antenna terminal) of radio frequency circuit 1. Antennas 2a and 2b receive radio frequency signals from radio frequency circuit 1, and externally output the radio frequency signals.

RFIC 3 is an example of a signal processing circuit that processes radio frequency signals. Specifically, RFIC 3 processes, by up-conversion, for instance, transmission signals input by a baseband integrated circuit (BBIC: not illustrated) and outputs radio frequency transmission signals generated by performing the processing on the transmission signals to a transmission path of radio frequency circuit 1. RFIC 3 includes a controller that controls, for instance, a switch circuit and an amplifier circuit that are included in radio frequency circuit 1. Note that some or all of the functions as the controller of RFIC 3 may be implemented outside of RFIC 3, and may be implemented in the BBIC or radio frequency circuit 1, for example.

Power supply circuit 4 is connected to power amplifiers 21 and 22 of radio frequency circuit 1, and supplies power supply voltages Vcc1 and Vcc2 to power amplifiers 21 and 22. Note that power supply circuit 4 may change the voltage values of power supply voltages Vcc1 and Vcc2 and supply power supply voltages Vcc1 and Vcc2 having the changed voltage values to power amplifiers 21 and 22. According to this, power supply circuit 4 can adjust the linearities of output powers of power amplifiers 21 and 22 relative to input powers.

Note that power supply circuit 4 may supply power supply voltages Vcc1 and Vcc2 to power amplifiers 21 and 22, according to control signals from RFIC 3. Further, power supply circuit 4 may be included in RFIC 3 or radio frequency circuit 1.

Note that antennas 2a and 2b and power supply circuit 4 are not necessary elements in communication device 5 according to the present embodiment.

### [1.2 Circuit Configuration of Radio Frequency Circuit 1]

Next, a circuit configuration of radio frequency circuit 1 is to be described. As illustrated in FIG. 1, radio frequency circuit 1 includes filters 11, 12, and 13, power amplifiers 21 and 22, switch 31, antenna terminals 110 and 120, and radio frequency input terminals 130 and 140. Filters 11 and 13, power amplifier 21, switch 31, antenna terminal 110, and radio frequency input terminal 130 are included in a first transfer circuit. Filter 12, power amplifier 22, antenna terminal 120, and radio frequency input terminal 140 are included in a second transfer circuit.

Radio frequency input terminal 130 is a terminal for receiving radio frequency transmission signals (hereinafter, stated as transmission signals) from the outside (RFIC 3) of radio frequency circuit 1. Radio frequency input terminal 140 is a terminal for receiving radio frequency transmission signals (hereinafter, stated as transmission signals) from the outside (RFIC 3) of radio frequency circuit 1.

Switch 31 includes common terminal 31a (a first common terminal), terminal 31b (a first terminal), and terminal 31c (a second terminal), and common terminal 31a is connected to antenna terminal 110. Switch 31 switches between connection and disconnection between common terminal 31a and terminal 31b and switches between connection and disconnection between common terminal 31a and terminal 31c. Switch 31 includes a single-pole double-throw (SPDT) switch circuit, for example.

Filter 11 is an example of a first filter, an input end thereof is connected to an output terminal of power amplifier 21, an output end thereof is connected to terminal 31b, and has a first passband that includes at least a portion of Band A (a first band). In other words, filter 11 is disposed on a first path that connects power amplifier 21 and antenna terminal 110. In radio frequency circuit 1, the first passband includes an uplink operating band of Band A.

Filter 12 is an example of a second filter, an input end thereof is connected to an output terminal of power amplifier 22, an output end thereof is connected to antenna terminal 120 via no switch, and has a second passband that includes at least a portion of Band B (a second band). In other words, filter 12 is disposed on a second path that connects power amplifier 22 and antenna terminal 120. In radio frequency circuit 1, the second passband includes an uplink operating band of Band B.

Filter 13 is an example of a third filter, one end thereof is connected to terminal 31c, and has a third passband that includes at least a portion of Band C.

Power amplifier 21 is an example of a first power amplifier and supports a first power class. Power amplifier 21 can amplify transmission signals in Band A in the first power class, which are input through radio frequency input terminal 130. Power amplifier 21 is connected between radio frequency input terminal 130 and filter 11.

Power amplifier 22 is an example of a second power amplifier and supports a second power class for a transmission power higher than that of the first class. Power amplifier 22 can amplify transmission signals in Band B in the second power class, which are input through radio frequency input terminal 140. Power amplifier 22 is connected between radio frequency input terminal 140 and filter 12.

With the above configuration, radio frequency circuit 1 can simultaneously transfer a transmission signal in Band A in the first power class and a transmission signal in Band B in the second power class.

Each of Band A, Band B, or Band C is a frequency band for a communication system established using a radio access technology (RAT), and is defined in advance by, for instance, a standardizing body (such as the 3rd Generation Partnership Project (3GPP (registered trademark)) or the Institute of Electrical and Electronics Engineers (IEEE), for example). Examples of such a communication system include a 5th Generation New Radio (5G NR) system, a Long Term Evolution (LTE) system, and a wireless local area network (WLAN) system, for instance, but the communication system is not limited thereto.

In the present embodiment, Band A includes a downlink operating band and an uplink operating band. Further, Band B includes a downlink operating band and an uplink operating band. Note that in each of Band A or Band B, the uplink operating band and the downlink operating band may coincide with each other, and the entire frequency ranges of Band A and Band B may be uplink operating bands and downlink operating bands.

Note that the uplink operating band means a frequency range designated for an uplink in each of the bands. Further, the downlink operating band means a frequency range designated for a downlink in each of the bands.

The power classes are classifications of output powers of UE defined according to maximum output powers, for instance, and a smaller value of the power class indicates that a higher power is allowed to be output. For example, in 3GPP (registered trademark), the maximum output power allowable in power class 1 is 31 dBm, the maximum output power allowable in power class 1.5 is 29 dBm, the maximum output power allowable in power class 2 is 26 dBm, and the maximum output power allowable in power class 3 is 23 dBm.

A maximum output power of UE is defined by an output power at an antenna end of the UE. The maximum output power of the UE is measured by using, for example, a method defined by 3GPP (registered trademark), for instance. For example, the maximum output power is measured by measuring radiant power at antenna 2a or 2b in FIG. 1. Note that instead of measuring radiant power, a terminal is provided in the vicinity of antenna 2a or 2b and a measurement instrument (such as a spectrum analyzer, for example) is connected to the terminal, so that the output power of antenna 2a or 2b can also be measured.

According to radio frequency circuit 1 according to the present embodiment, no switch is disposed on the second path through which transmission signals in the second power class for a high transmission power, and thus signal distortion due to a switch can be reduced. Thus, intermodulation distortion caused by interference of a signal in Band A and a signal in Band B and harmonics in Band B can be reduced. Thus, deterioration in quality of signals in Band A and Band B can be reduced.

Note that Band B may be a time division duplex band, and each of the second passband or the third passband may include Band B in this case.

According to this, a transmission signal in Band B can be transferred through the second path on which filter 12 is disposed, and a reception signal in Band B can be transferred through a reception path on which filter 13 is disposed. At this time, a switch for transmitting and receiving signals in Band B in a time-division manner is not disposed on the second path, and thus distortion of the transmission signal in Band B due to a switch can be reduced.

Under a condition that Band B is a time division duplex band and each of the second passband or the third passband includes Band B, the first transfer circuit and the second transfer circuit may be mounted on the same board. According to this, filters 12 and 13 each including Band B as a passband can be provided on the same board, and thus a piezoelectric board in a case in which filters 12 and 13 are acoustic wave filters can be shared, and thus the loss and size of radio frequency circuit 1 can be reduced.

Note that a voltage value of power supply voltage Vcc2 supplied to power amplifier 22 under a condition that the transmission signal in Band A in the first power class and the transmission signal in Band B in the second power class are simultaneously transmitted may be identical to a voltage value of power supply voltage Vcc2 supplied to power amplifier 22 under a condition that the transmission signal in Band B in the second power class is transmitted without transmitting the transmission signal in Band A in the first power class.

If a switch is disposed on the second path, intermodulation distortion is caused in the switch due to a transmission signal in Band B and a transmission signal in Band A that leaks from the first path. Accordingly, with a conventional technology, in a case in which a transmission signal in Band A and a transmission signal in Band B are simultaneously transferred, power supply voltage Vcc2 supplied to power amplifier 22 is increased to improve the linearity of a transmission signal in Band B on the second path.

In contrast, according to the configuration of radio frequency circuit 1 according to the present embodiment, no switch is disposed on the second path, and thus the occurrence of intermodulation distortion on the second path in a case in which a transmission signal in Band A and a transmission signal in Band B are simultaneously transferred can be reduced. Thus, in the case in which a transmission signal in Band A and a transmission signal in Band B are simultaneously transferred, power supply voltage Vcc2 supplied to power amplifier 22 does not need to be set high. Thus, power consumption can be reduced while the occurrence of intermodulation distortion due to interference between a transmission signal in Band A and a transmission signal in Band B is reduced.

### [1.3 Circuit Configuration of Radio Frequency Circuit 1A According to Variation 1]

Next, a circuit configuration of radio frequency circuit 1A according to Variation 1 is to be described.

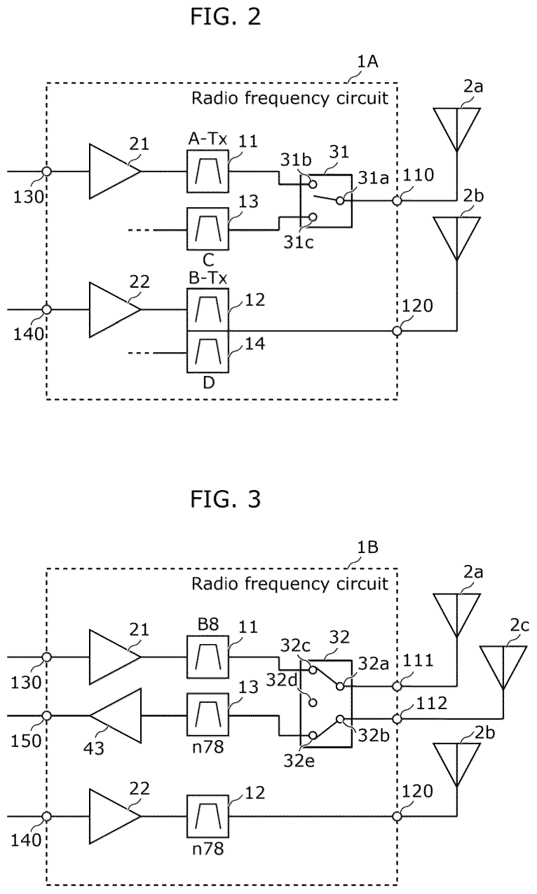

FIG. 2 illustrates a circuit configuration of radio frequency circuit 1A according to Variation 1. As illustrated in FIG. 2, radio frequency circuit 1A includes filters 11, 12, 13, and 14, power amplifiers 21 and 22, switch 31, antenna terminals 110 and 120, and radio frequency input terminals 130 and 140. Filters 11 and 13, power amplifier 21, switch 31, antenna terminal 110, and radio frequency input terminal 130 are included in a first transfer circuit. Filters 12 and 14, power amplifier 22, antenna terminal 120, and radio frequency input terminal 140 are included in a second transfer circuit. Radio frequency circuit 1A according to this variation is different from radio frequency circuit 1 according to Embodiment 1 in that filter 14 is additionally included. In the following description of radio frequency circuit 1A according to this variation, description of the same points as radio frequency circuit 1 according to Embodiment 1 is omitted, and different points from radio frequency circuit 1 are mainly described.

Filter 14 is an example of a fourth filter, one end thereof is connected to an output end of filter 12 via no switch, and has a fourth passband.

According to the above configuration of radio frequency circuit 1A, filters 12 and 14 constitute a diplexer (or a duplexer) in which the output end of filter 12 and the one end of filter 14 are directly connected. Thus, signals that pass through filter 14 can be transferred with low loss.

Note that the fourth passband may include at least a portion of Band D different from Band B. According to this, filters 12 and 14 can constitute a diplexer (or a duplexer) that can transfer two signals in different bands with low loss.

Note that in this case, Band B may be a time division duplex band, and each of the second passband or the third passband may include Band B. According to this, a transmission signal in Band B can be transferred through the second path on which filter 12 is disposed, and a reception signal in Band B can be transferred through a reception path on which filter 13 is disposed. At this time, a switch for transmitting and receiving signals in Band B in a time-division manner is not disposed on the second path, and thus distortion of the transmission signal in Band B due to a switch can be reduced.

Table 1 shows examples of combinations of Band A, Band B, Band C, and Band D in radio frequency circuit 1A according to Variation 1.

TABLE 1

| | First transfer circuit | | Second transfer circuit | |
|---|---|---|---|---|
| | Band A | Band C | Band B | Band D |
| | (Filter 11) | (Filter 13) | (Filter 12) | (Filter 14) |
| Ex. 1 | Any of | Any of | Any of | Any of |
| | B1/B3/B5/B8/ | B1/B3/B5/B8/ | n77/n78/n79 | n77/n78/n79 |
| | B20/B28/B40/ | B20/B28/B40/ | (For | (Band different |
| | B41/B71 | B41/B71 | transmission) | from Band B) |
| | (For | | | |
| | transmission) | | | |
| Ex. 2 | Any of | Any of | B41 | B40 |
| | B1/B3/B5/B8/ | B1/B3/B5/B8/ | (For | |
| | B20/B28/B71 | B20/B28/B71 | transmission) | |
| | (For | | | |
| | transmission) | | | |
| Ex. 3 | Any of | Any of | Any of | Any of |
| | B1/B3/B5/B8/ | n77/n78/n79 | n77/n78/n79 | n77/n78/n79 |
| | B20/B28/B40/ | (For | (For | (Band different |
| | B41 | reception) | transmission) | from Band B) |
| | (For | | | |
| | transmission) | | | |
| Ex. 4 | Any of | Any of | B41 | B40 |
| | B1/B3/B5/B8/ | B40/B41 | (For | |
| | B20/B28/B71 | (For | transmission) | |
| | (For | reception) | | |
| | transmission) | | | |

In Ex. 1 illustrated in Table 1, Band A is any LTE band out of Band 1 (1920 MHz to 1980 MHz, 2110 MHz to 2170 MHz), Band 3 (1710 MHz to 1785 MHz, 1805 MHz to 1880 MHz), Band 5 (824 MHZ to 849 MHz, 869 MHz to 894 MHZ), Band 8 (880 MHz to 915 MHZ, 925 MHz to 960 MHZ), Band 20 (832 MHz to 862 MHZ, 791 MHz to 821 MHz), Band 28 (703 MHz to 748 MHz, 758 MHz to 803 MHZ), Band 40 (2300 MHz to 2400 MHZ), Band 41 (2496 MHz to 2690 MHZ) and Band 71 (663 MHz to 698 MHZ, 617 MHz to 652 MHZ) or any of 5G NR Band n1, n3, n5, n8, n20, n28, n40, n41, or n71. Band B is any of 5G NR Band n77 (3.3 GHz to 4.2 GHz), Band n78 (3.3 GHz to 3.8 GHz), or Band n79 (4.4 GHz to 5.0 GHz). Band C is any of LTE Band 1, 3, 5, 8, 20, 28, 40, 41, or 71 or any of 5G NR Band n1, n3, n5, n8, n20, n28, n40, n41, or n71. Band D is any of 5G NR band n77, n78, or n79, and is different from Band B.

In Ex. 2, Band A is any of LTE Band 1, 3, 5, 8, 20, 28, or 71 or any of 5G NR Band n1, n3, n5, n8, n20, n28, or n71. Band B is LTE Band 41 or 5G NR Band n41. Band C is any of LTE Band 1, 3, 5, 8, 20, 28, or 71 or any of 5G NR Band n1, n3, n5, n8, n20, n28, or n71. Band D is LTE Band 40 or 5G NR Band n40.

In Ex. 3, Band A is any of LTE Band 1, 3, 5, 8, 20, 28, 40, or 41 or any of 5G NR Band n1, n3, n5, n8, n20, n28, n40, or n41. Band B is any of 5G NR band n77, n78, or n79. Band C is any of 5G NR band n77, n78, or n79. Band D is any of 5G NR band n77, n78, or n79, and is different from Band B.

In Ex. 4, Band A is any of LTE Band 1, 3, 5, 8, 20, 28, or 71 or any of 5G NR Band n1, n3, n5, n8, n20, n28, or n71. Band B is LTE Band 41 or 5G NR Band n41. Band C is any of LTE Band 40 or 41 or any of 5G NR Band n40 or n41. Band D is LTE Band 40 or 5G NR Band n40.

Note that filter 14 may be connected to a power amplifier that supports a second power class different from the power class of power amplifier 22. According to this, a transmission signal in Band D in the second power class and a transmission signal in Band B in the second power class are amplified by separate power amplifiers and thereafter pass through filter 12 and filter 14, respectively. Thus, distortion of the signals in a plurality of bands (Band B and Band D) in the second class can be reduced.

### [1.4 Circuit Configuration of Radio Frequency Circuit 1B According to Variation 2]

Next, a circuit configuration of radio frequency circuit 1B according to Variation 2 is to be described.

FIG. 3 illustrates a circuit configuration of radio frequency circuit 1B according to Variation 2. As illustrated in FIG. 3, radio frequency circuit 1B includes filters 11, 12, and 13, power amplifiers 21 and 22, low-noise amplifier 43, switch 32, antenna terminals 111, 112, and 120, radio frequency input terminals 130 and 140, and radio frequency output terminal 150. Filters 11 and 13, power amplifier 21, low-noise amplifier 43, switch 32, antenna terminals 111 and 112, radio frequency input terminal 130, and radio frequency output terminal 150 are included in a first transfer circuit. Filter 12, power amplifier 22, antenna terminal 120, and radio frequency input terminal 140 are included in a second transfer circuit. Radio frequency circuit 1B according to this variation is different from radio frequency circuit 1 according to Embodiment 1 in configurations of the switch and the antenna terminals and in that low-noise amplifier 43 is additionally included. In the following description of radio frequency circuit 1B according to this variation, description of the same points as radio frequency circuit 1 according to Embodiment 1 is omitted, and different points from radio frequency circuit 1 are mainly described.

Antenna terminal 111 is an example of a first antenna terminal, and is connected to antenna 2a. Antenna terminal 112 is an example of a third antenna terminal, and is connected to antenna 2c different from antenna 2a. Antenna terminal 120 is an example of a second antenna terminal, and is connected to antenna 2b different from antennas 2a and 2c.

Radio frequency circuit 150 is an output terminal for supplying a reception signal in Band C to the outside (RFIC 3) of radio frequency circuit 1B.

Switch 32 includes common terminal 32a (a first common terminal), common terminal 32b (a second common terminal), terminal 32c (a first terminal), terminal 32d, and terminal 32e (a second terminal), and common terminal 32a is connected to antenna terminal 111, whereas common terminal 32b is connected to antenna terminal 112. Switch 32 switches between connection and disconnection between common terminal 32a and terminal 32c and switches between connection and disconnection between common terminal 32b and terminal 32e. Switch 32 selectively switches connection of common terminal 32a between terminal 32c and terminal 32d, and selectively switches connection of common terminal 32b between terminal 32e and terminal 32d, for example. Switch 32 includes a double-pole triple-throw (DP3T) switch circuit, for example.

Filter 11 is an example of a first filter, an input end thereof is connected to an output terminal of power amplifier 21, an output end thereof is connected to terminal 32c, and has a first passband that includes at least a portion of Band A (a first band). Stated differently, filter 11 is disposed on a first path that connects power amplifier 21 and antenna terminal 111. In radio frequency circuit 1B, Band A is LTE Band 8, for example, and the first passband includes an uplink operating band of Band 8.

Filter 12 is an example of a second filter, an input end thereof is connected to an output terminal of power amplifier 22, an output end thereof is connected to antenna terminal 120 via no switch, and has a second passband that includes at least a portion of Band B (a second band). Stated differently, filter 12 is disposed on a second path that connects power amplifier 22 and antenna terminal 120. In radio frequency circuit 1B, Band B is 5G NR Band n78, for example, and the second passband includes Band n78.

Filter 13 is an example of a third filter, is connected between terminal 32e and low-noise amplifier 43, and has a third passband that includes at least a portion of Band C. More specifically, one end of filter 13 is connected to terminal 32e, and another end is connected to an input terminal of low-noise amplifier 43. In radio frequency circuit 1B, Band C is 5G NR Band n78, for example, and the third passband includes Band n78.

Low-noise amplifier 43 is an example of a first low-noise amplifier, and can amplify a reception signal in Band C input through antenna terminal 112. Low-noise amplifier 43 is connected between radio frequency output terminal 150 and filter 13.

In the above configuration, radio frequency circuit 1B can output, to antenna 2a, a transmission signal in Band 8 in the first power class through radio frequency input terminal 130, power amplifier 21, filter 11, switch 32, and antenna terminal 111 and can simultaneously output, to antenna 2b, a transmission signal in Band n78 in the second power class through radio frequency input terminal 140, power amplifier 22, filter 12, and antenna terminal 120, by connecting common terminal 32a to terminal 32c and connecting common terminal 32b to terminal 32d.

Further, radio frequency circuit 1B can output, to antenna 2a, a transmission signal in Band 8 in the first power class through radio frequency input terminal 130, power amplifier 21, filter 11, switch 32, and antenna terminal 111 and can simultaneously output, from radio frequency output terminal 150, a reception signal in Band n78 through antenna 2c, antenna terminal 112, switch 32, filter 13, and low-noise amplifier 43, by connecting common terminal 32a to terminal 32c and connecting common terminal 32b to terminal 32e.

According to this, a transmission signal in Band n78 can be transferred through the second path on which filter 12 is disposed, simultaneously with transfer of a transmission signal in Band 8. At this time, a switch for transmitting and receiving signals in Band n78 in a time-division manner is not disposed on the second path, and thus distortion of the transmission signal in Band n78 due to a switch can be reduced. Further, a reception signal in Band n78 can be transferred through a path on which filter 13 is disposed, simultaneously with transfer of the transmission signal in Band 8.

### [1.5 Circuit Configuration of Radio Frequency Circuit 1C According to Variation 3]

Next, a circuit configuration of radio frequency circuit 1C according to Variation 3 is to be described.

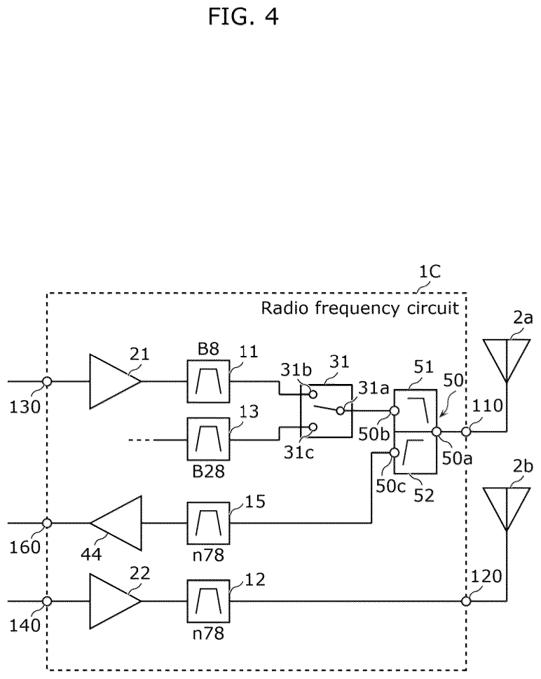

FIG. 4 illustrates a circuit configuration of radio frequency circuit 1C according to Variation 3. As illustrated in FIG. 4, radio frequency circuit 1C includes filters 11, 12, 13, and 15, power amplifiers 21 and 22, low-noise amplifier 44, switch 31, diplexer 50, antenna terminals 110 and 120, radio frequency input terminals 130 and 140, and radio frequency output terminal 160. Filters 11, 13, and 15, power amplifier 21, low-noise amplifier 44, switch 31, diplexer 50, antenna terminal 110, radio frequency input terminal 130, and radio frequency output terminal 160 are included in a first transfer circuit. Filter 12, power amplifier 22, antenna terminal 120, and radio frequency input terminal 140 are included in a second transfer circuit. Radio frequency circuit 1C according to this variation is different from radio frequency circuit 1 according to Embodiment 1 in that diplexer 50, filter 15, and low-noise amplifier 44 are additionally included. In the following description of radio frequency circuit 1C according to this variation, description of the same points as radio frequency circuit 1 according to Embodiment 1 is omitted, and different points from radio frequency circuit 1 are mainly described.

Radio frequency circuit 160 is an output terminal for supplying a reception signal in Band n78 to the outside (RFIC 3) of radio frequency circuit 1C.

Switch 31 includes common terminal 31a (a first common terminal), terminal 31b (a first terminal), and terminal 31c (a second terminal), and common terminal 31a is connected to antenna terminal 110 via filter 51. Switch 31 switches between connection and disconnection between common terminal 31a and terminal 31b and switches between connection and disconnection between common terminal 31a and terminal 31c. Switch 31 includes an SPDT switch circuit, for example.

Filter 11 is an example of a first filter, an input end thereof is connected to an output terminal of power amplifier 21, an output end thereof is connected to terminal 31b, and has a first passband that includes at least a portion of Band A (a first band). Stated differently, filter 11 is disposed on a first path that connects power amplifier 21 and antenna terminal 110. In radio frequency circuit 1C, Band A is LTE Band 8, for example, and the first passband includes an uplink operating band of Band 8.

Filter 12 is an example of a second filter, an input end thereof is connected to an output terminal of power amplifier 22, an output end thereof is connected to antenna terminal 120 via no switch, and has a second passband that includes at least a portion of Band B (a second band). Stated differently, filter 12 is disposed on a second path that connects power amplifier 22 and antenna terminal 120. In radio frequency circuit 1C, Band B is 5G NR Band n78, for example, and the second passband includes Band n78.

Filter 13 is an example of a third filter, one end thereof is connected to terminal 31c, and has a third passband that includes at least a portion of Band C. In radio frequency circuit 1C, Band C is Band 28, for example, and the third passband includes an uplink or downlink operating band of Band 28.

Filter 15 is an example of a fifth filter, an input end thereof is connected to antenna terminal 110 via filter 52, an output end thereof is connected to an input terminal of low-noise amplifier 44, and has a fifth passband that includes Band n78. Thus, each of the second passband or the fifth passband includes Band B.

Diplexer 50 includes common terminal 50a (a third common terminal), terminal 50b (a third terminal), and terminal 50c (a fourth terminal), and is connected between antenna terminal 110 and filter 15 and switch 31. Diplexer 50 includes filters 51 and 52. One end of filter 51 is common terminal 50a, and another end is terminal 50b. One end of filter 52 is common terminal 50a, and another end is terminal 50c. Filter 51 is a low-pass filter, for example, whereas filter 52 is a high-pass filter, for example.

Common terminal 50a is connected to antenna terminal 110, terminal 50b is connected to common terminal 31a, terminal 50c is connected to an input end of filter 15, and an output end of filter 15 is connected to low-noise amplifier 44.

Low-noise amplifier 44 is an example of a second low-noise amplifier, and can amplify a reception signal in Band n78 input through antenna terminal 110. Low-noise amplifier 44 is connected between radio frequency output terminal 160 and diplexer 50.

In the above configuration, radio frequency circuit 1C can output, to antenna 2a, a transmission signal in Band 8 in the first power class through radio frequency input terminal 130, power amplifier 21, filter 11, switch 31, filter 51, and antenna terminal 110 by connecting common terminal 31a to terminal 31b. Further, simultaneously with the transmission signal in Band 8 in the first power class, radio frequency circuit 1C can output, to antenna 2b, a transmission signal in Band n78 in the second power class, through radio frequency input terminal 140, power amplifier 22, filter 12, and antenna terminal 120. Alternatively, simultaneously with the transmission signal in Band 8 in the first power class, radio frequency circuit 1C can output, from radio frequency output terminal 160, a reception signal in Band n78, through antenna 2a, antenna terminal 110, filter 52, filter 15, and low-noise amplifier 44.

According to this, a transmission signal in Band n78 can be transferred through the second path on which filter 12 is disposed, simultaneously with transfer of a transmission signal in Band 8. At this time, a switch for transmitting and receiving signals in Band n78 in a time-division manner is not disposed on the second path, and thus distortion of the transmission signal in Band n78 due to a switch can be reduced. Further, a reception signal in Band n78 can be transferred through a path on which filter 15 is disposed, simultaneously with transfer of the transmission signal in Band 8.

### [1.6 Effects and Others]

As described above, radio frequency circuit 1 according to the present embodiment is a radio frequency circuit configured to simultaneously transfer a signal in Band A in a first power class and a signal in Band B in a second power class for a transmission power higher than a transmission power of the first power class, the radio frequency circuit including: antenna terminal 110; antenna terminal 120; power amplifier 21 configured to support the first power class; power amplifier 22 configured to support the second power class; switch 31 that includes common terminal 31a, terminal 31b, and terminal 31c, common terminal 31a being connected to antenna terminal 110; filter 11 that includes an input end connected to power amplifier 21 and an output end connected to terminal 31b, filter 11 having a first passband that includes at least a portion of Band A; filter 12 that includes an input end connected to power amplifier 22 and an output end connected to antenna terminal 120 via no switch, filter 12 having a second passband that includes at least a portion of Band B; and filter 13 connected to terminal 31c, filter 13 having a third passband.

According to this, no switch is disposed on the path through which transmission signals in the second power class for a higher transmission power are transferred, and thus signal distortion due to a switch can be reduced. Thus, intermodulation distortion caused by interference of a signal in Band A and a signal in Band B and harmonics in Band B can be reduced. Thus, radio frequency circuit 1 that reduces deterioration in quality of signals in a power class that allows a higher maximum output power than that of a conventional power class can be provided.

For example, in radio frequency circuit 1, Band B may be a time division duplex band, and the second passband and the third passband may each include Band B.

According to this, a transmission signal in Band B can be transferred through the second path on which filter 12 is disposed, and a reception signal in Band B can be transferred through a reception path on which filter 13 is disposed. At this time, a switch for transmitting and receiving signals in Band B in a time-division manner is not disposed on the second path, and thus distortion of the transmission signal in Band B due to a switch can be reduced.

For example, radio frequency circuit 1A according to Variation 1 may further include: filter 14 that includes an end connected to the output end of filter 12 via no switch, filter 14 having a fourth passband.

According to this, filters 12 and 14 constitute a diplexer (or a duplexer) in which the output end of filter 12 and the one end of filter 14 are directly connected. Thus, signals that pass through filter 14 can be transferred with low loss.

For example, in radio frequency circuit 1A, the fourth passband may include at least a portion of Band D different from Band B.

According to this, filters 12 and 14 can constitute a diplexer (or a duplexer) that can transfer two signals in different bands with low loss.

For example, in radio frequency circuit 1, a voltage value of power supply voltage Vcc2 supplied to power amplifier 22 under a condition that the signal in Band A in the first power class and the signal in the Band B in the second power class are simultaneously transmitted may be identical to a voltage value of power supply voltage Vcc2 supplied to power amplifier 22 under a condition that the signal in Band B in the second power class is transmitted without transmitting the signal in Band A in the first power class.

According to this, no switch is disposed on the second path on which filter 12 is disposed, and thus the occurrence of intermodulation distortion on the second path in a case in which a transmission signal in Band A and a transmission signal in Band B are simultaneously transferred can be reduced. Thus, in the case in which a transmission signal in Band A and a transmission signal in Band B are simultaneously transferred, power supply voltage Vcc2 supplied to power amplifier 22 does not need to be set high. Thus, power consumption can be reduced while the occurrence of intermodulation distortion due to interference between a transmission signal in Band A and a transmission signal in Band B is reduced.

For example, in radio frequency circuits 1 and 1A, switch 31 may be configured to: switch between connection and disconnection between common terminal 31a and terminal 31b; and switch between connection and disconnection between common terminal 31a and terminal 31c.

For example, radio frequency circuit 1B according to Variation 2 includes: antenna terminals 111, 112, and 120; power amplifier 21 configured to support the first power class; power amplifier 22 configured to support the second power class; low-noise amplifier 43; switch 32 that includes common terminals 32a and 32b, terminals 32c, 32d, and 32e, common terminal 32a being connected to antenna terminal 111, common terminal 32b being connected to antenna terminal 112; filter 11 that includes an input end connected to power amplifier 21 and an output end connected to terminal 32c, filter 11 having a first passband that includes at least a portion of Band A; filter 12 that includes an input end connected to power amplifier 22 and an output end connected to antenna terminal 120 via no switch, filter 12 having a second passband that includes at least a portion of Band B; and filter 13 connected between terminal 32e and low-noise amplifier 43, filter 13 having a third passband. Switch 32 may be configured to: switch between connection and disconnection between common terminal 32a and terminal 32c; and switch between connection and disconnection between common terminal 32b and terminal 32e.

According to this, a transmission signal in Band B can be transferred through the second path on which filter 12 is disposed, simultaneously with transfer of a transmission signal in Band A. At this time, a switch for transmitting and receiving signals in Band B in a time-division manner is not disposed on the second path, and thus distortion of the transmission signal in Band B due to a switch can be reduced. Further, a reception signal in Band B can be transferred through a path on which filter 13 is disposed, simultaneously with transfer of the transmission signal in Band A.

For example, radio frequency circuit 1C according to Variation 3 includes: antenna terminal 110; antenna terminal 120; power amplifier 21 configured to support the first power class; power amplifier 22 configured to support the second power class; low-noise amplifier 44; switch 31 that includes common terminal 31a, terminal 31b, and terminal 31c, common terminal 31a being connected to antenna terminal 110 via diplexer 50; filter 11 that includes an input end connected to power amplifier 21 and an output end connected to terminal 31b, filter 11 having a first passband that includes at least a portion of Band A; filter 12 that includes an input end connected to power amplifier 22 and an output end connected to antenna terminal 120 via no switch, filter 12 having a second passband that includes at least a portion of Band B; filter 13 connected to terminal 31c, filter 13 having a third passband; filter 15 having a fifth passband; and diplexer 50 that includes common terminal 50a, terminal 50b, and terminal 50c, diplexer 50 being connected between (i) antenna terminal 110 and (ii) filter 15 and switch 31. Common terminal 50a may be connected to antenna terminal 110, terminal 50b may be connected to common terminal 31a, terminal 50c may be connected to an input end of filter 15, an output end of filter 15 may be connected to low-noise amplifier 44, Band B may be a time division duplex band, and the second passband and the fifth passband may each include Band B.

According to this, a transmission signal in Band B can be transferred through the second path on which filter 12 is disposed, simultaneously with transfer of a transmission signal in Band A. At this time, a switch for transmitting and receiving signals in Band B in a time-division manner is not disposed on the second path, and thus distortion of the transmission signal in Band B due to a switch can be reduced. Further, a reception signal in Band B can be transferred through a path on which filter 15 is disposed, simultaneously with transfer of the transmission signal in Band A.

For example, communication device 5 according to the embodiment includes: RFIC 3 configured to process radio frequency signals; and radio frequency circuit 1 configured to transfer the radio frequency signals between RFIC 3 and antennas 2a and 2b.

According to this, effects achieved by radio frequency circuit 1 can be yielded by communication device 5.

### Embodiment 2

### [2 Circuit Configuration of Radio Frequency Circuit 1D and Communication Device 5D]

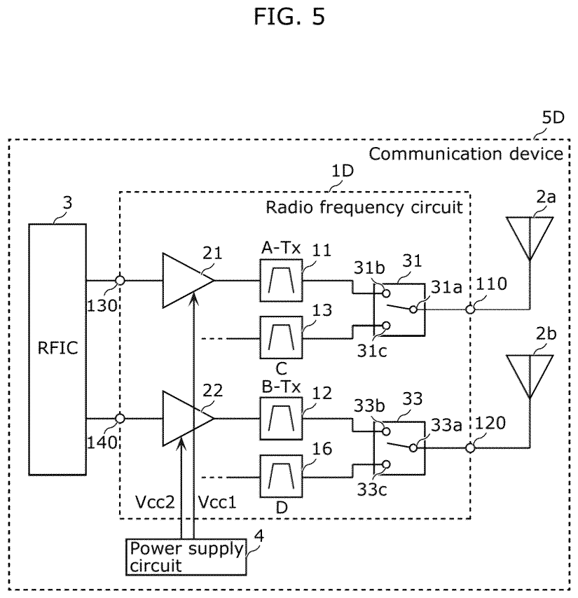

A circuit configuration of radio frequency circuit 1D according to the present embodiment and communication device 5D that includes radio frequency circuit 1D is to be described with reference to FIG. 5. FIG. 5 illustrates a circuit configuration of radio frequency circuit 1D and communication device 5D according to Embodiment 2.

### [2.1 Circuit Configuration of Communication Device 5D]

Communication device 5D corresponds to so-called user equipment (UE), and is typically a mobile phone, a smartphone, or a tablet computer, for instance. Such communication device 5D includes radio frequency circuit 1D, antennas 2a and 2b, RFIC 3, and power supply circuit 4. Communication device 5D according to the present embodiment is different from communication device 5 according to Embodiment 1 in the configuration of radio frequency circuit 1D. Thus, a configuration of radio frequency circuit 1D is to be described in the following.

### [2.2 Circuit Configuration of Radio Frequency Circuit 1D]

As illustrated in FIG. 5, radio frequency circuit 1D includes filters 11, 12, 13, and 16, power amplifiers 21 and 22, switches 31 and 33, antenna terminals 110 and 120, and radio frequency input terminals 130 and 140. Filters 11 and 13, power amplifier 21, switch 31, antenna terminal 110, and radio frequency input terminal 130 are included in a first transfer circuit. Filters 12 and 16, power amplifier 22, switch 33, antenna terminal 120, and radio frequency input terminal 140 are included in a second transfer circuit. Radio frequency circuit 1D according to the present embodiment is different from radio frequency circuit 1 according to Embodiment 1 in the configuration of the second transfer circuit. In the following description of radio frequency circuit 1D according to the present embodiment, description of the same points as radio frequency circuit 1 according to Embodiment 1 is omitted, and different points from radio frequency circuit 1 are mainly described.

Radio frequency input terminal 130 is a terminal for receiving transmission signals from the outside (RFIC 3) of radio frequency circuit 1D. Radio frequency input terminal 140 is a terminal for receiving transmission signals from the outside (RFIC 3) of radio frequency circuit 1D.

Switch 31 is an example of a first switch, and includes common terminal 31a (a first common terminal), terminal 31b (a first terminal), and terminal 31c (a second terminal), and common terminal 31a is connected to antenna terminal 110. Switch 31 switches between connection and disconnection between common terminal 31a and terminal 31b and switches between connection and disconnection between common terminal 31a and terminal 31c. Switch 31 includes a single-pole double-throw (SPDT) switch circuit, for example.

Switch 31 includes a silicon semiconductor. The silicon semiconductor includes Si as a main material. Switch 31 includes, for example, a complementary metal oxide semiconductor (CMOS) transistor or a transistor manufactured by a silicon on insulator (SOI) process.

Switch 33 is an example of a second switch, and includes common terminal 33a (a second common terminal), terminal 33b (a third terminal), and terminal 33c (a fourth terminal), and common terminal 33a is connected to antenna terminal 120. Switch 33 switches between connection and disconnection between common terminal 33a and terminal 33b and switches between connection and disconnection between common terminal 33a and terminal 33c. Switch 33 includes an SPDT switch circuit, for example.

Switch 33 includes a compound semiconductor. The compound semiconductor includes a compound such as GaN or GaAs, as a main material. Switch 33 includes a pseudomorphic high electron mobility transistor (PHEMT) or a metal oxide semiconductor high electron mobility transistor (MOSHEMT) that includes the compound semiconductor.

Switch 33 that includes a compound semiconductor has higher power durability and can reduce signal distortion more, as compared to switch 31 that includes a silicon semiconductor. On the other hand, switch 31 that includes a silicon semiconductor is less expensive, as compared to switch 33 that includes a compound semiconductor.

Filter 11 is an example of a first filter, an input end thereof is connected to an output terminal of power amplifier 21, an output end thereof is connected to terminal 31b, and has a first passband that includes at least a portion of Band A (a first band). In radio frequency circuit 1D, the first passband includes an uplink operating band of Band A.

Filter 12 is an example of a second filter, an input end thereof is connected to an output terminal of power amplifier 22, an output end thereof is connected to terminal 33b, and has a second passband that includes at least a portion of Band B (a second band). In radio frequency circuit 1D, the second passband includes an uplink operating band of Band B.

Filter 13 is an example of a third filter, one end thereof is connected to terminal 31c, and has a third passband that includes at least a portion of Band C.

Filter 16 is an example of a fourth filter, one end thereof is connected to terminal 33c, and has a fourth passband that includes at least a portion of Band D.

Power amplifier 21 is an example of a first power amplifier and supports a first power class. Power amplifier 21 can amplify transmission signals in Band A in the first power class, which are input through radio frequency input terminal 130. Power amplifier 21 is connected between radio frequency input terminal 130 and filter 11.

Power amplifier 22 is an example of a second power amplifier and supports a second power class for a higher transmission power than that of the first class. Power amplifier 22 can amplify transmission signals in Band B in the second power class, which are input through radio frequency input terminal 140. Power amplifier 22 is connected between radio frequency input terminal 140 and filter 12.

With the above configuration, radio frequency circuit 1D can simultaneously transfer a transmission signal in Band A in the first power class and a transmission signal in Band B in the second power class.

According to radio frequency circuit 1D according to the present embodiment, switch 33 having high power durability is disposed on the second path that connects filter 12 and antenna terminal 120 and through which transmission signals in the second power class for a higher transmission power are transferred, and thus signal distortion due to a switch can be reduced. Thus, intermodulation distortion caused by interference of a signal in Band A and a signal in Band B and harmonics in Band B can be reduced.

On the other hand, low-cost switch 31 is disposed on the first path that connects filter 11 and antenna terminal 110 and through which signals in the first power class for a lower transmission power are transmitted.

Accordingly, low-cost radio frequency circuit 1D that reduces deterioration in quality of signals in Band A and Band B can be provided.

Note that Band B may be a time division duplex band, and the fourth passband may include Band B in this case.

According to this, switch 33 can be used as a switch for transmitting and receiving signals in Band B in a time-division manner.

Note that a voltage value of power supply voltage Vcc2 supplied to power amplifier 22 under a condition that the transmission signal in Band A in the first power class and the transmission signal in Band B in the second power class are simultaneously transmitted may be identical to a voltage value of power supply voltage Vcc2 supplied to power amplifier 22 under a condition that the transmission signal in Band B in the second power class is transmitted without transmitting the transmission signal in Band A in the first power class.

According to the configuration of radio frequency circuit 1D according to the present embodiment, switch 33 having high power durability is disposed on the second path, and thus the occurrence of intermodulation distortion on the second path in a case in which a transmission signal in Band A and a transmission signal in Band B are simultaneously transferred can be reduced. Thus, in the case in which a transmission signal in Band A and a transmission signal in Band B are simultaneously transferred, power supply voltage Vcc2 supplied to power amplifier 22 does not need to be set high. Thus, power consumption can be reduced while the occurrence of intermodulation distortion due to interference between a transmission signal in Band A and a transmission signal in Band B is reduced.

### [2.3 Effects and Others]

As described above, radio frequency circuit 1D according to the present embodiment is a radio frequency circuit configured to simultaneously transfer a signal in Band A in a first power class and a signal in Band B in a second power class for a transmission power higher than a transmission power of the first power class, the radio frequency circuit including: antenna terminal 110; antenna terminal 120; power amplifier 21 configured to support the first power class; power amplifier 22 configured to support the second power class; switch 31 that includes common terminal 31a, terminal 31b, and terminal 31c, common terminal 31a being connected to antenna terminal 110; switch 33 that includes common terminal 33a, terminal 33b, and terminal 33c, common terminal 33a being connected to antenna terminal 120; filter 11 that includes an input end connected to power amplifier 21 and an output end connected to terminal 31b, filter 11 having a first passband that includes at least a portion of Band A; filter 12 that includes an input end connected to power amplifier 22 and an output end connected to terminal 33b, filter 12 having a second passband that includes at least a portion of Band B; filter 13 connected to terminal 31c, filter 13 having a third passband; and filter 16 connected to terminal 33c, filter 16 having a fourth passband. Switch 31 includes a silicon semiconductor, and switch 33 includes a compound semiconductor.

According to this, switch 33 having high power durability is disposed on the second path that connects filter 12 and antenna terminal 120 and through which transmission signals in the second power class for a higher transmission power are transferred, and thus signal distortion due to a switch can be reduced. Thus, intermodulation distortion caused by interference of a signal in Band A and a signal in Band B and harmonics in Band B can be reduced. On the other hand, low-cost switch 31 is disposed on the first path that connects filter 11 and antenna terminal 110 and through which signals in the first power class for a lower transmission power are transmitted. Thus, low-cost radio frequency circuit 1D that reduces deterioration in quality of signals in Band A and Band B can be provided.

Communication device 5D according to the embodiment includes: RFIC 3 configured to process radio frequency signals; and radio frequency circuit 1D configured to transfer the radio frequency signals between RFIC 3 and antennas 2a and 2b.

According to this, effects achieved by radio frequency circuit 1D can be yielded by communication device 5D.

### Other Embodiments

The above has described the radio frequency circuit and the communication device according to the present disclosure, based on the embodiments and variations, but the radio frequency circuit and the communication device according to the present disclosure are not limited to the above embodiments or the variations thereof. The present disclosure also encompasses another embodiment achieved by combining arbitrary elements in the above embodiments and variations thereof, variations resulting from applying, to the embodiments and variations thereof, various modifications that may be conceived by those skilled in the art within a range that does not depart from the scope of the present disclosure, and various devices that each include the radio frequency circuit and the communication device.

For example, in the circuit configurations of the radio frequency circuit and the communication device according to the above embodiments and variations, another circuit element and a line, for instance, may be connected to a path that connects circuit elements and signal paths shown on the drawings.

In the above embodiments, 5G NR or LTE bands are used, yet a communication band for another radio access technology may be used in addition to or instead of 5G NR or LTE. For example, a communication band for a wireless local area network (WLAN) may be used. Further, a millimeter-wave band of at least 7 GHz may be used, for example. In this case, any of radio frequency circuit 1 or 1A to 1D, antennas 2a and 2b, and RFIC 3 may be included in a millimeter-wave antenna module, and a distributed constant filter, for example, may be used as the filter.

For example, in Embodiments 1 and 2, Band A (the first band) may be a WLAN band of at least 5 GHz or may be a new radio (NR) band (including a licensed or unlicensed band) between 5.125 GHz to 7.125 GHz.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to communication devices such as mobile phones as a radio frequency circuit disposed at a front end portion.

1. A radio frequency circuit configured to simultaneously transfer a signal in a first band in a first power class and a signal in a second band in a second power class for a transmission power higher than a transmission power of the first power class, the radio frequency circuit comprising:
a first antenna terminal;
a second antenna terminal;
a first power amplifier configured to support the first power class;
a second power amplifier configured to support the second power class;
a switch that includes a first common terminal, a first terminal, and a second terminal, the first common terminal being connected to the first antenna terminal;
a first filter that includes an input end connected to the first power amplifier and an output end connected to the first terminal, the first filter having a first passband that includes at least a portion of the first band;
a second filter that includes an input end connected to the second power amplifier and an output end connected to the second antenna terminal via no switch, the second filter having a second passband that includes at least a portion of the second band; and
a third filter connected to the second terminal, the third filter having a third passband.

2. The radio frequency circuit according to claim 1,
wherein the second band is a time division duplex band, and
the second passband and the third passband each include the second band.

3. The radio frequency circuit according to claim 1, further comprising:
a fourth filter that includes an end connected to the output end of the second filter via no switch, the fourth filter having a fourth passband.

4. The radio frequency circuit according to claim 3,
wherein the fourth passband includes at least a portion of a third band different from the second band.

5. The radio frequency circuit according to claim 1,
wherein a voltage value of a power supply voltage supplied to the second power amplifier under a condition that the signal in the first band in the first power class and the signal in the second band in the second power class are simultaneously transmitted is identical to a voltage value of the power supply voltage supplied to the second power amplifier under a condition that the signal in the second band in the second power class is transmitted without transmitting the signal in the first band in the first power class.

6. The radio frequency circuit according to claim 1,
wherein the switch is configured to:
switch between connection and disconnection between the first common terminal and the first terminal; and
switch between connection and disconnection between the first common terminal and the second terminal.

7. The radio frequency circuit according to claim 1, further comprising:
a third antenna terminal; and
a first low-noise amplifier,
wherein the switch further includes a second common terminal connected to the third antenna terminal,
the third filter is connected between the second terminal and the first low-noise amplifier, and
the switch is configured to:
switch between connection and disconnection between the first common terminal and the first terminal; and
switch between connection and disconnection between the second common terminal and the second terminal.

8. The radio frequency circuit according to claim 1, further comprising:
a fifth filter having a fifth passband;
a diplexer that includes a third common terminal, a third terminal, and a fourth terminal, the diplexer being connected between (i) the first antenna terminal and (ii) the fifth filter and the switch; and
a second low-noise amplifier,
wherein the third common terminal is connected to the first antenna terminal,
the third terminal is connected to the first common terminal,
the fourth terminal is connected to an input end of the fifth filter,
an output end of the fifth filter is connected to the second low-noise amplifier,
the second band is a time division duplex band, and
the second passband and the fifth passband each include the second band.

9. A radio frequency circuit configured to simultaneously transfer a signal in a first band in a first power class and a signal in a second band in a second power class for a transmission power higher than a transmission power of the first power class, the radio frequency circuit comprising:
a first antenna terminal;
a second antenna terminal;
a first power amplifier configured to support the first power class;
a second power amplifier configured to support the second power class;
a first switch that includes a first common terminal, a first terminal, and a second terminal, the first common terminal being connected to the first antenna terminal;
a second switch that includes a second common terminal, a third terminal, and a fourth terminal, the second common terminal being connected to the second antenna terminal;
a first filter that includes an input end connected to the first power amplifier and an output end connected to the first terminal, the first filter having a first passband that includes at least a portion of the first band;
a second filter that includes an input end connected to the second power amplifier and an output end connected to the third terminal, the second filter having a second passband that includes at least a portion of the second band;
a third filter connected to the second terminal, the third filter having a third passband; and
a fourth filter connected to the fourth terminal, the fourth filter having a fourth passband,
wherein the first switch includes a silicon semiconductor, and
the second switch includes a compound semiconductor.

10. A communication device comprising:
a signal processing circuit configured to process a radio frequency signal; and
the radio frequency circuit according to claim 1 configured to transfer the radio frequency signal between the signal processing circuit and an antenna.

11. The radio frequency circuit according to claim 1, further comprising:
a fifth filter having a fifth passband.

12. The radio frequency circuit according to claim 11, further comprising:
a diplexer that includes a third common terminal, a third terminal, and a fourth terminal, the diplexer being connected between (i) the first antenna terminal and (ii) the fifth filter and the switch.

13. The radio frequency circuit according to claim 12, further comprising:
a second low-noise amplifier,
wherein the third common terminal is connected to the first antenna terminal,
the third terminal is connected to the first common terminal,
the fourth terminal is connected to an input end of the fifth filter,
an output end of the fifth filter is connected to the second low-noise amplifier,
the second band is a time division duplex band, and
the second passband and the fifth passband each include the second band.

14. The radio frequency circuit according to claim 1, further comprising:
a third antenna terminal.

15. The radio frequency circuit according to claim 14, further comprising:
a first low-noise amplifier,
wherein the switch further includes a second common terminal connected to the third antenna terminal.

16. The radio frequency circuit according to claim 15,
the third filter is connected between the second terminal and the first low-noise amplifier, and
the switch is configured to:
switch between connection and disconnection between the first common terminal and the first terminal; and
switch between connection and disconnection between the second common terminal and the second terminal.

17. A communication device comprising:
a signal processing circuit configured to process a radio frequency signal; and
the radio frequency circuit according to claim 9 configured to transfer the radio frequency signal between the signal processing circuit and an antenna.

18. A communication device comprising:
a signal processing circuit configured to process a radio frequency signal; and
the radio frequency circuit according to claim 2 configured to transfer the radio frequency signal between the signal processing circuit and an antenna.

19. A communication device comprising:
a signal processing circuit configured to process a radio frequency signal; and
the radio frequency circuit according to claim 4 configured to transfer the radio frequency signal between the signal processing circuit and an antenna.

20. A communication device comprising:
a signal processing circuit configured to process a radio frequency signal; and
the radio frequency circuit according to claim 5 configured to transfer the radio frequency signal between the signal processing circuit and an antenna.
